(19) United States
(12) Patent Application Publication
(10) Pub. No.: US 2022/0402668 A1
(43) Pub. Date: Dec. 22, 2022

(54) Compositions Suitable for Making Edible Films or Coatings

(71) Applicant: The United States of America, as Represented by the Secretary of Agriculture, Washington, DC (US)

(72) Inventors: ZHONGLIN T. JIN, North Wales, PA (US); MADHAV P. YADAV, North Wales, PA (US); PHOEBE X QI, Philadelphia, PA (US)

(21) Appl. No.: 17/836,955

(22) Filed: Jun. 9, 2022

Related U.S. Application Data
(60) Provisional application No. 63/209,205, filed on Jun. 10, 2021.

(51) Int. Cl. B65D 65/46; B65D 65/42; B29C 41/02; B29C 41/00; B29B 7/74; B29B 13/06

(52) U.S. Cl. CPC B65D 65/463; B65D 65/42; B29C 41/02; B29C 41/003; B29B 7/74; B29B 13/06; B29K 2089/00; B29K 2995/0037; B29L 2007/008

(57) ABSTRACT

A composition suitable for making edible films or coatings, the composition comprising a conjugate of bio fiber gum and whey protein isolate and at least one food grade antimicrobial.

### REFERENCE TO RELATED APPLICATIONS

This application claims the benefit of U.S. Provisional Application No. 63/209,205, filed Jun. 10, 2021, which is incorporated herein by reference in its entirety.

### BACKGROUND OF THE INVENTION

Disclosed herein are compositions suitable for making edible films or coatings, said composition containing a conjugate of bio-fiber gum and whey protein isolate, and at least one food grade antimicrobial (e.g., carvacrol (CAR)).

Foodborne illness outbreaks and food waste are currently the two most significant challenges for consumers, food industries, and scientists alike. These challenges are linked to the microbiological conditions of the commodity. The Centers for Disease Control and Prevention (CDC) estimated 9.4 million foodborne illnesses each year (Scallan, E. et al., Emerging infectious diseases, 17(1): 16-22 (2011)). During 2009-2015, the Foodborne Disease Outbreak Surveillance System (FDOSS) (https://www.cdc.gov/fdoss/) received reports of 5,760 outbreaks, resulting in 100,939 illnesses, 5,699 hospitalizations, and 145 deaths (Dewey-Mattia, D., Morbidity, and Mortality Weekly Report, Surveillance Summaries, 67(10): 1-11 (2018)). Foodborne illness incurs a $77.7 billion annual economic burden in the United States based on an enhanced cost-of-illness model (Scharff, R. L., Journal of Food Protection, 75(1): 123-131 (2012)).

Food waste is also a significant concern in terms of economic losses and environmental impact. Yu and Jaenicke (Yu, Y., and E. C. Jaenicke, American Journal of Agricultural Economics, 102(2): 525-547 (2020)) reported that the average household in the United States wastes 31.9% of its purchases. This is equivalent to an annual U.S. consumer-level food waste value of $240 billion. Among the top reasons for the wasted food, 83% is spoilage (International Food Information Council Foundation, A Survey of Consumer Behaviors and Perceptions of Food Waste (2019)). The Food and Agriculture Organization (FAQ) of the United Nations estimated that 1.3 billion tons of food, one-third of all food produced for human consumption, is lost or wasted worldwide every year (Depta, L., Global Food Waste and its Environmental Impact (2018); FAO, Global Initiative on Food Loss and Waste (2017)). The FAO also estimated that the food wastage carbon footprint is about 4.4 gigatons of greenhouse gas (CO2) per year, which would be, if treated as a country, the third-largest carbon-emitting country in the world, after the U.S. and China (Scialabba, N. E.-H. et al., Food wastage footprint: Impacts on natural resources, Summary Report, pp. 63, Food and Agriculture Organization of the United Nations (2013)).

Consumer demand for minimally processed prepared foods has dramatically increased in recent years. These foods are processed and packaged with relatively little or no heat to reduce thermal damage, allowing better quality. However, a central issue with such foods is that they are not sterile. As a result, the risk of microbiological contamination significantly increases, raising concerns about their safety, short shelf-life, and increased waste.

Packaging plays a critical role in ensuring food safety and extending shelf life by preventing microbial contamination. However, conventional packaging cannot inactivate microorganisms that already exist in foods before packaging, or contamination may occur via packaging materials and package machines during the packaging process. These microorganisms could survive or even grow during post-packaging storage and transportation. As a result, these foods' quality can deteriorate, raising concerns about their safety and shelf life.

Antimicrobial packaging encompasses any packaging technique(s) used to control microbial growth in a food product, preserving its quality and safety. An antimicrobial packaging system includes packaging materials and antimicrobial agents, and techniques that modify the atmosphere within the package. Food packaging containing antimicrobials would enable the antimicrobials to be released gradually from the film or coating and thus maintain a relatively high concentration of the antimicrobials on the food surface for a longer time (Ye, M. et al., International Journal of Food Microbiology, 127(3): 235-240 (2008)). There are increasingly growing needs for antimicrobial packaging systems made with natural, biodegradable, environment-friendly packaging materials and safe and effective antimicrobial agents suitable for various types of foods.

A unique packaging material was developed in our previous studies by incorporating barley fiber gum (BFG) in chitosan (CHI). Edible antimicrobial composite films and coatings based on these two polymers with added antimicrobials (e.g., organic acid, essential oils, lauric arginate ester) demonstrated excellent antimicrobial activity against foodborne pathogens as well as spoilage microorganisms in ready-to-eat meat samples and fresh strawberries. They played a critical role in extending shelf life and reducing spoilage and waste (Guo, M. et al., Journal of Food Protection, 81(8): 1227-1235 (2018); Guo, M. et al., International Journal of Food Microbiology, 208: 58-64 (2015); Guo, M. et al., International Journal of Food Microbiology, 263: 9-16 (2017)). However, the films from BFG+CHI composite polymers had high water solubility, gas permeability, and low mechanical strength, thus limiting their applications for high moisture foods.

We have now developed novel high-quality edible food packaging films and coatings. In our current study, corn bio-fiber gum (BFG) was modified by conjugating it with whey protein isolate (WPI) through a Maillard-type reaction, WPI:BFG, and used as a film-forming material to improve the film's functionalities, including antimicrobial properties, water sensitivity, gas permeability, and mechanical strength. BFG+CHI composite films and coatings were also evaluated and compared with other materials.

### SUMMARY OF THE INVENTION

Disclosed herein are compositions suitable for making edible films or coatings, said composition containing a conjugate of bio-fiber gum and whey protein isolate, and at least one food-grade antimicrobial.

This summary is provided to introduce a selection of concepts in a simplified form that is further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

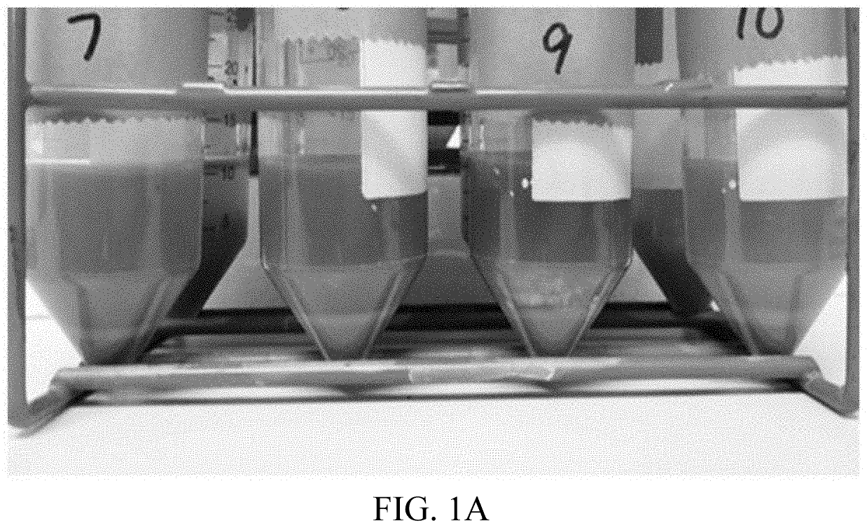

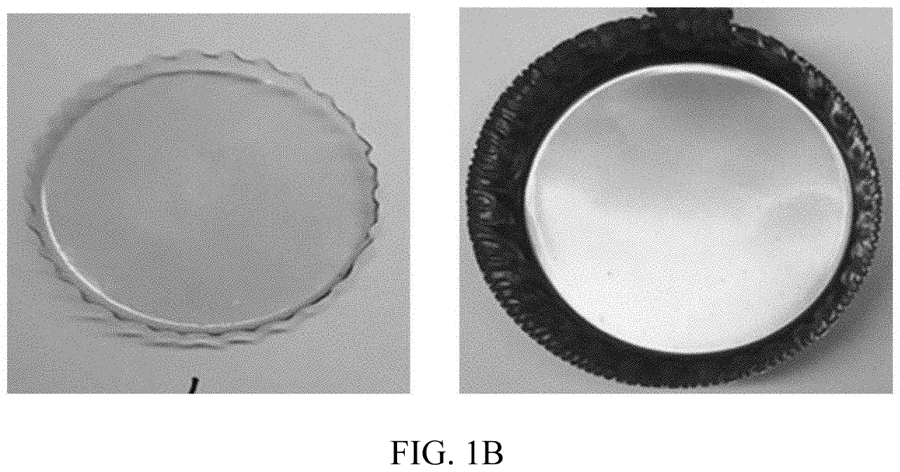

Exemplary FIGS. 1.A. and 1.B. shows samples of coating solutions (1.A.) and films (1.B.) as described below.

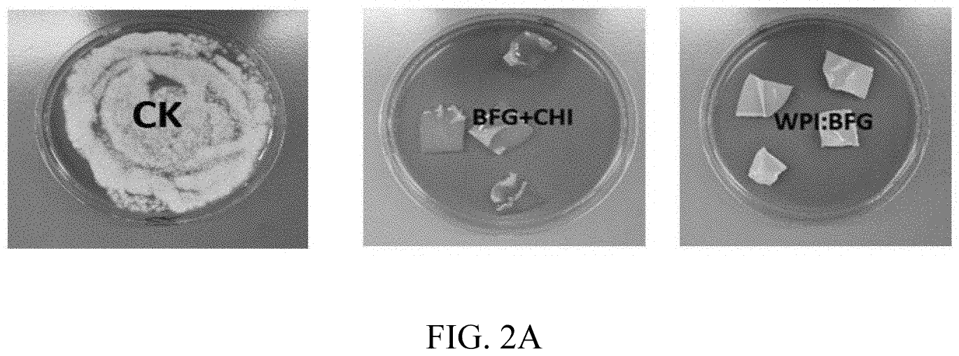

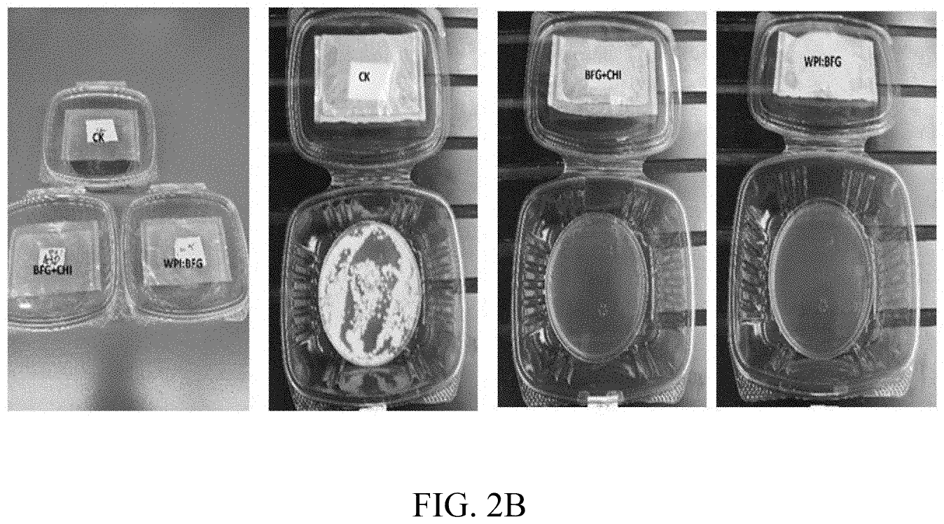

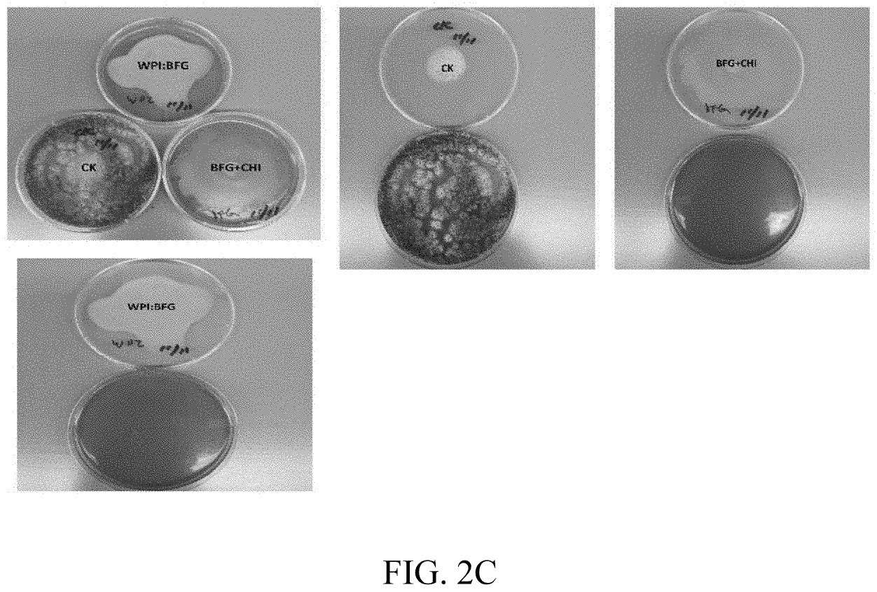

Exemplary FIGS. 2.A 2.B., and 2.C. shows methods to test the antimicrobial activities of films as described below. (2.A.): direct surface contact; (2.B): films on lids (headspace release); (2.C.): coating on covers (headspace release). Bread fungi were used on Dichloran Rose-Bengal Chloramphenicol Agar (DRBC) plates after 5 days at 25° C. Both films contained 1% carvacrol.

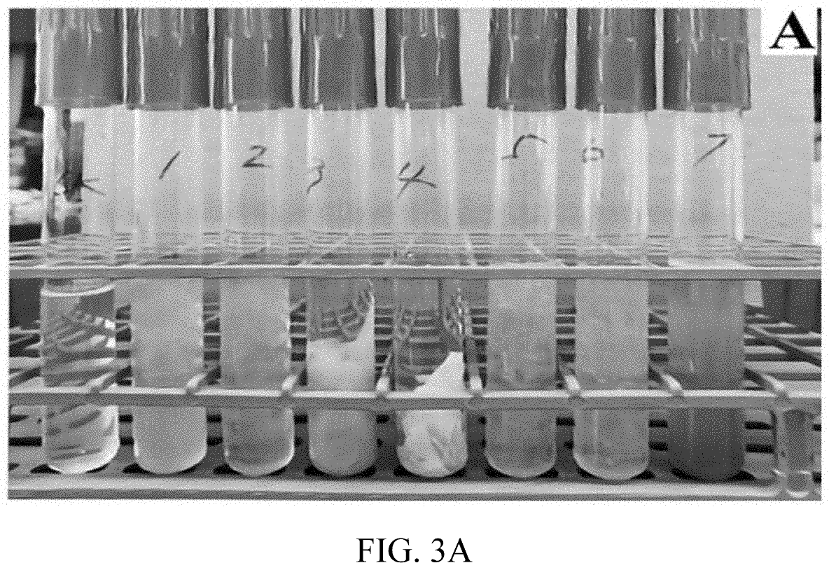

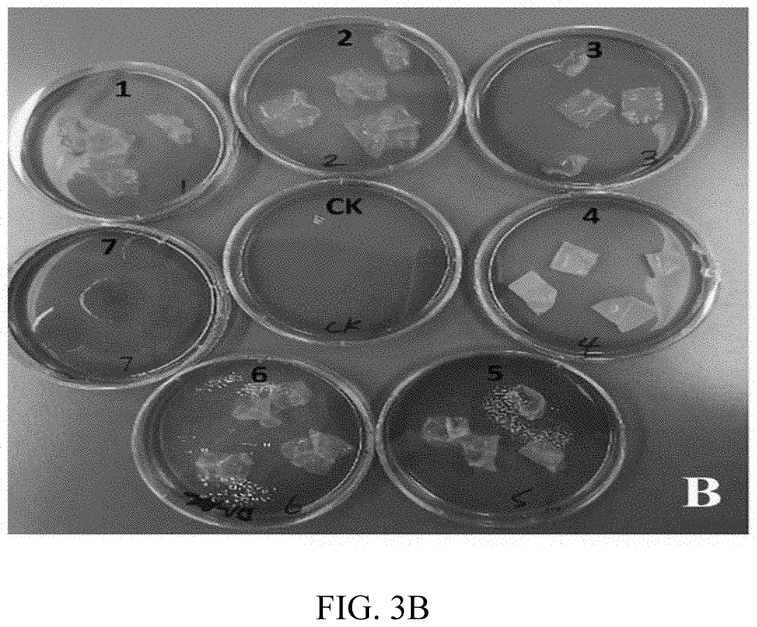

Exemplary FIGS. 3.A. and 3.B. shows films in peptone water (3.A.); and films on agar plates (3.B) after one day at room temperature as described below.

In (3.B.): Film 1: BFG+CHI; Film 2: BFG+CHI+CAR; Film 3: WPI:BFG; Film 4: WPI:BFG+CAR; Films 5-7: films with other formulas.

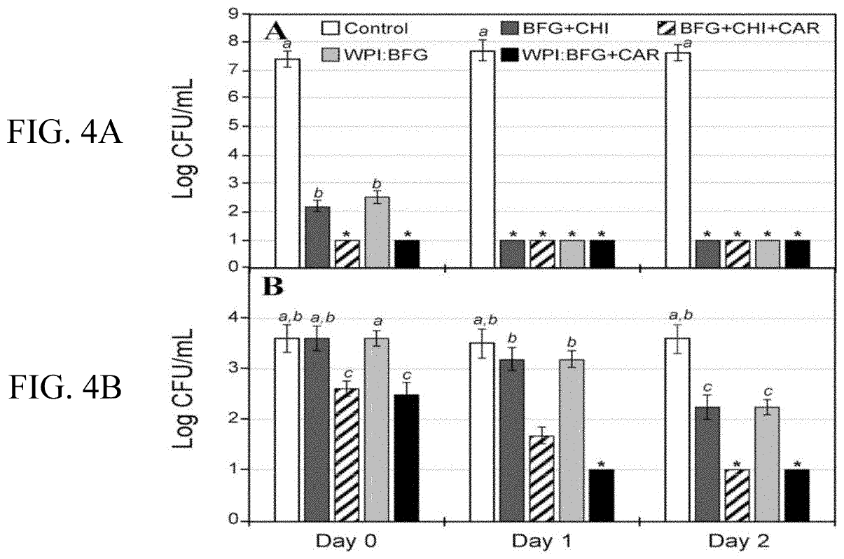

Exemplary FIGS. 4.A., and 4.B. shows the inactivation of Salmonella (4.A) and bread fungi (4.B) in peptone water at room temperature, as described below. *Under the detectable limit. Data sharing the same letter are not significantly different (P>0.05).

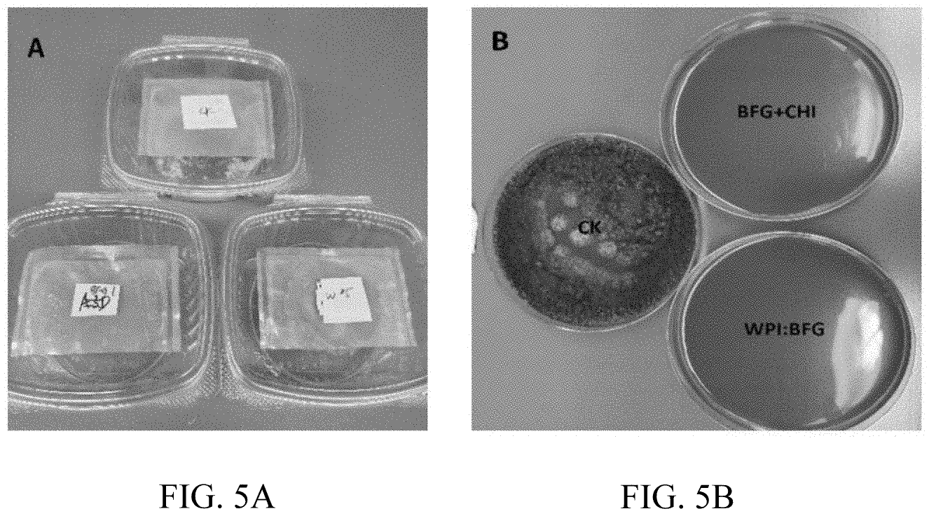

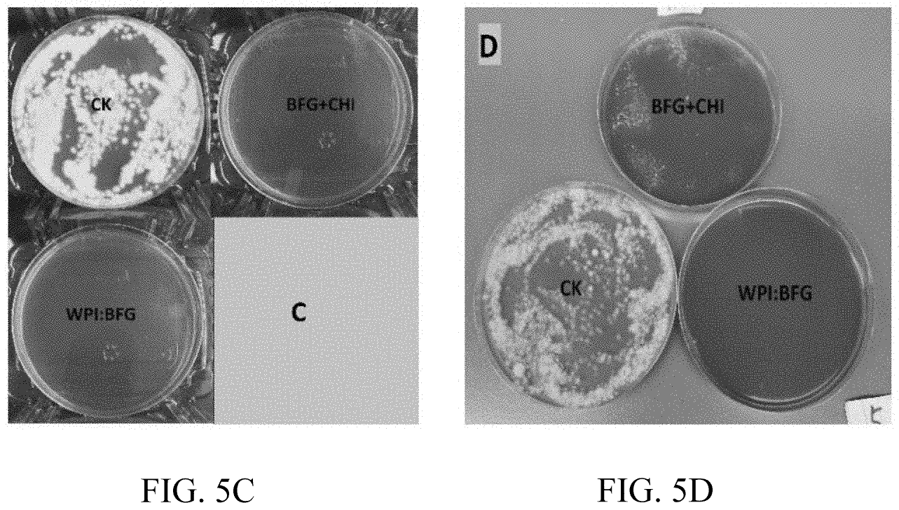

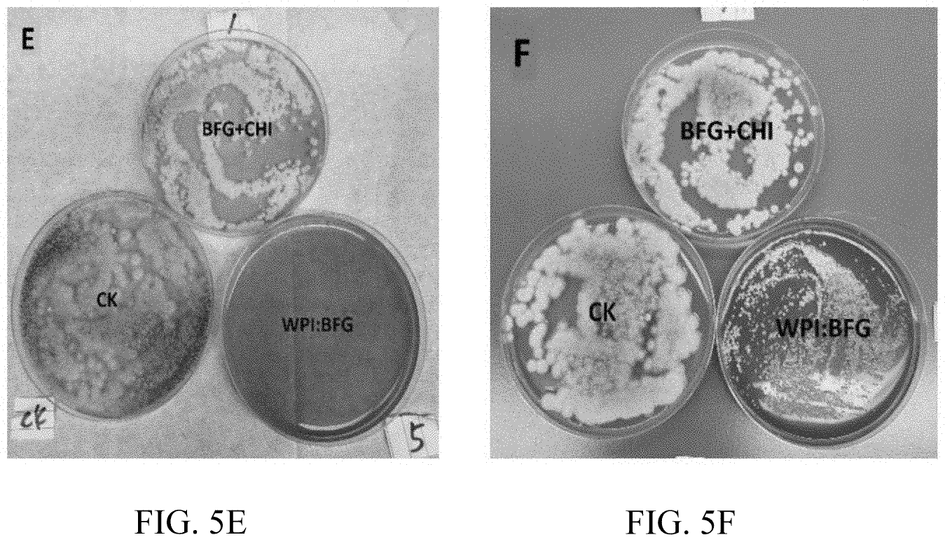

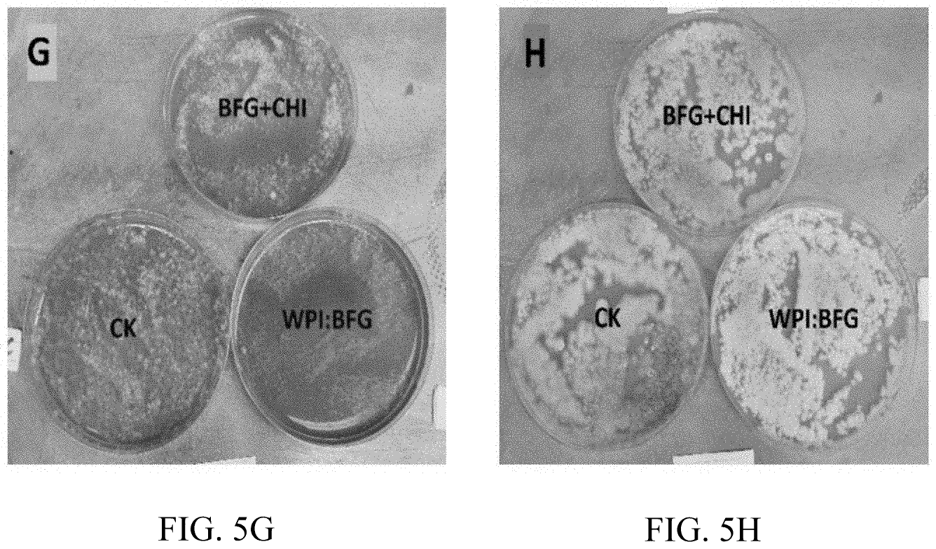

Exemplary FIG. 5.A.-5.H. shows antimicrobial properties of films after repeated uses as described below. The same films and boxes were reused. The boxes were opened and reloaded with new inoculated DRBC plates and incubated at 25° C. every 5 days. Bread fungi were used. (5.A): Film/boxes with inoculated plates inside; (5.B): Film/box was used the first time (Day 0-Day 5); (5C): Same film/box was used the second time (Day 5-Day 10); (5.D): Same film/box was used the third time (Day 10-Day 15); (5.E): Same film/box was used the fourth time (Day 15-Day 20): Same film/box was used the fifth time. The WPI:BFG film was reused five times and surprisingly only showed colonies after 25 days (FIG. 5.F.) and 30 days (FIG. 5.G.). Both films completely lost their antifungal activities through headspace release after being reused seven times throughout the 35-day incubation period (FIG. 5.H.).

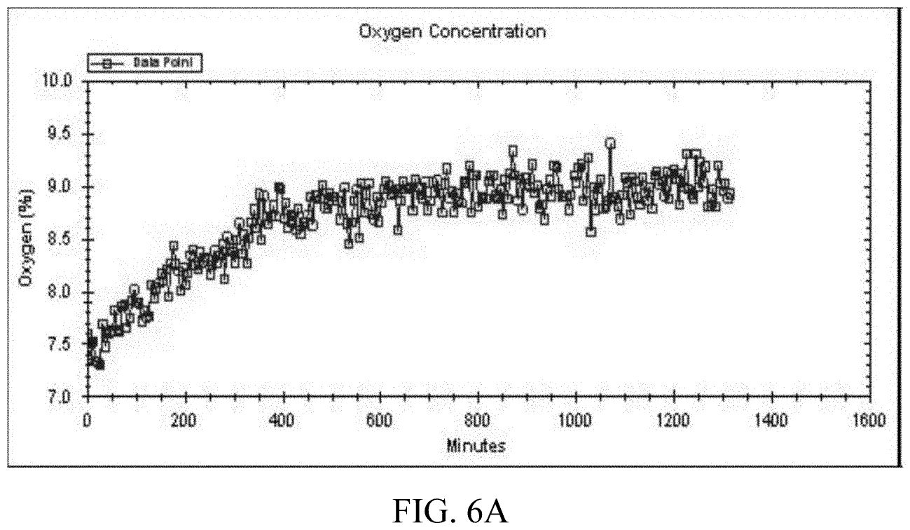

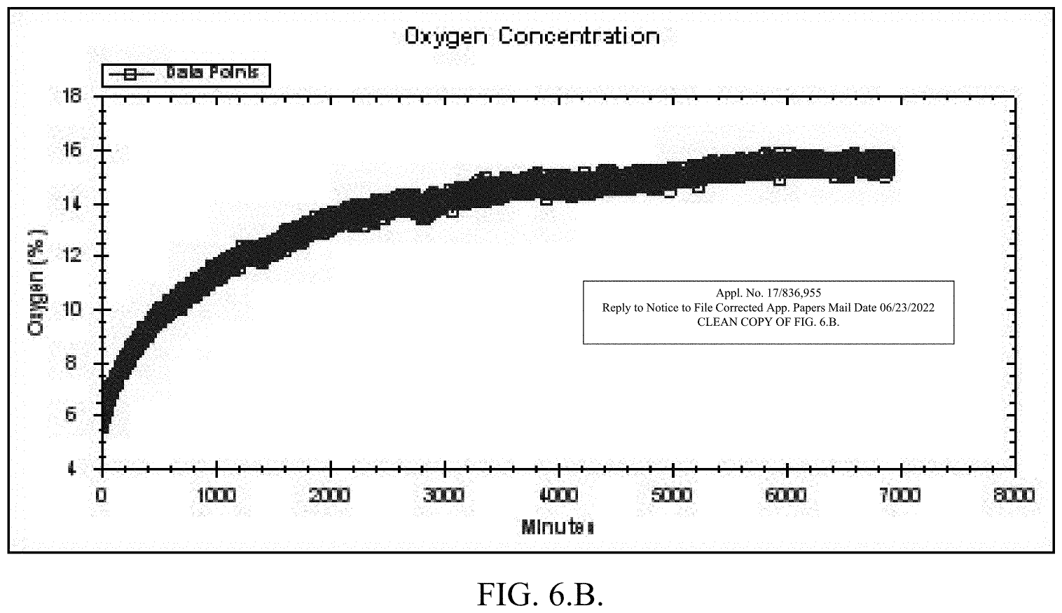

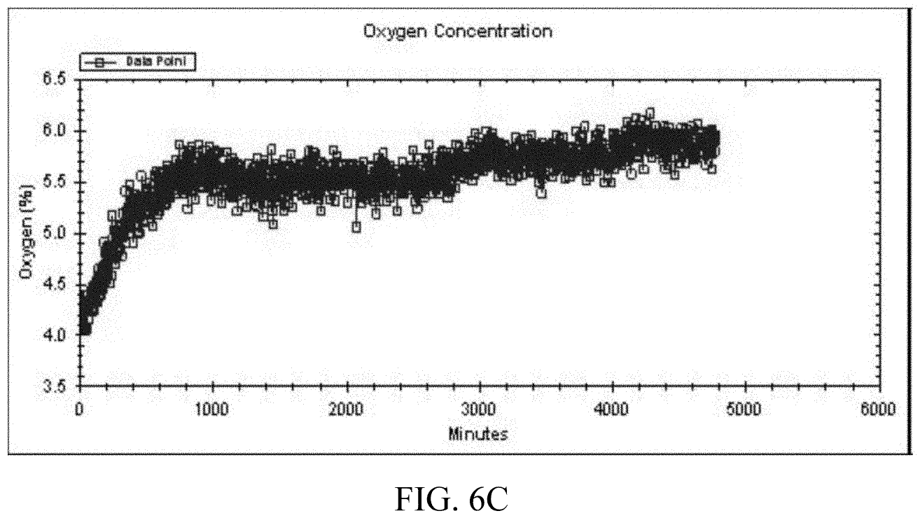

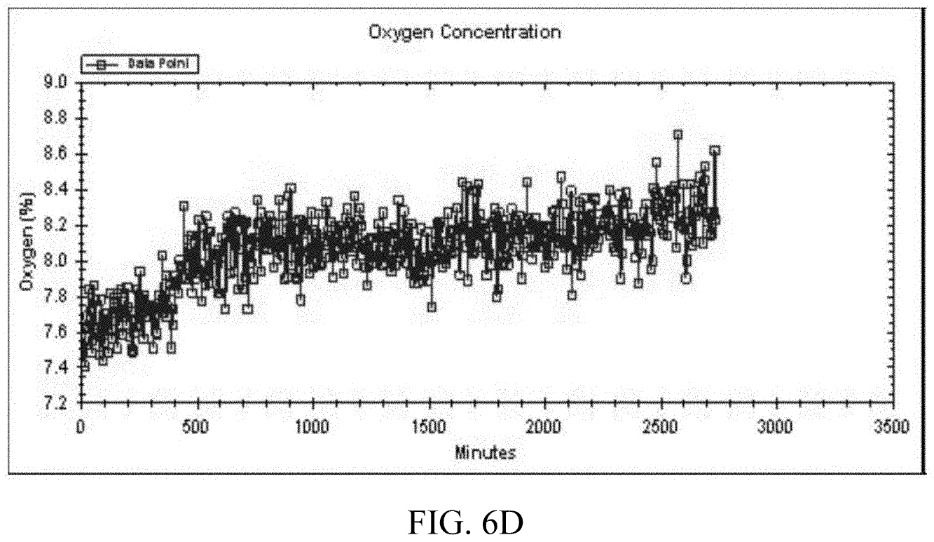

Exemplary FIG. 6.A.-6.D. shows oxygen transmission profiles of films as described below. (6.A): BFG+CHI+CAR; (6.B): BFG+CHI; (6.C): WPI:BFG+CAR film; (6.D): WPI:BFG film.

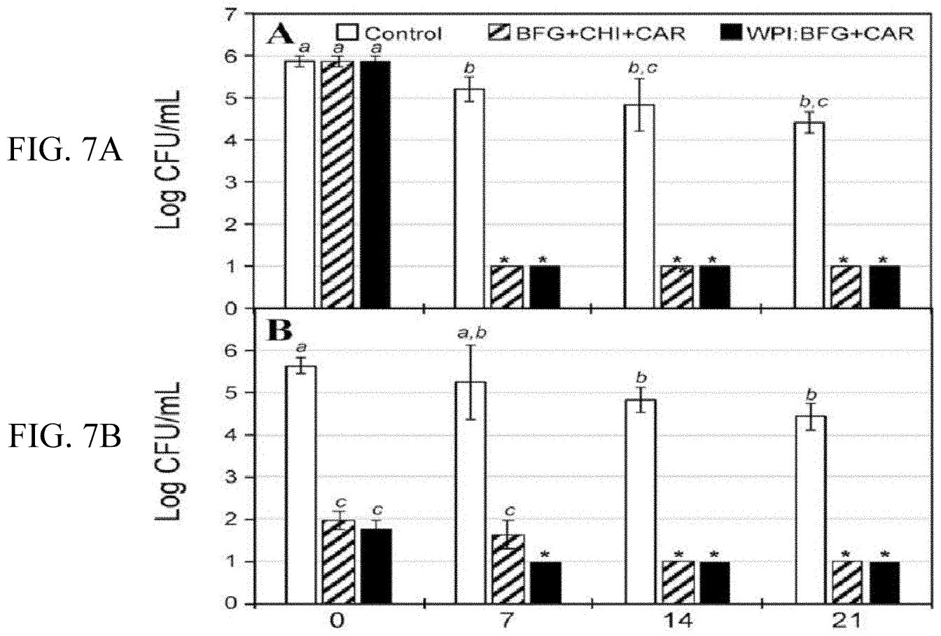

Exemplary FIGS. 7.A. and 7.B. shows the survival of Escherichia coli on grape tomatoes after treatments and during storage at 4° C., as described below. (7.A): film in headspace; (7.B): direct coating. *Under the detectable limit. Data sharing the same letter are not significantly different (P>0.05).

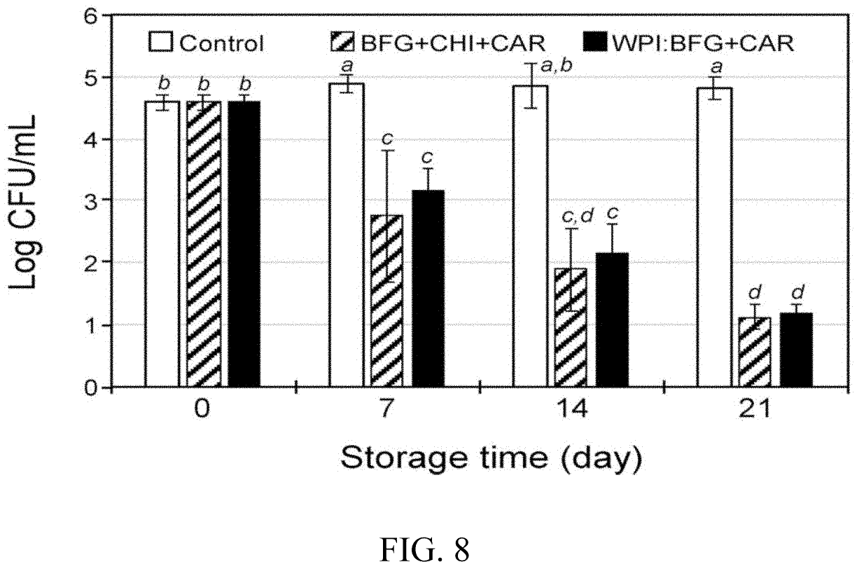

Exemplary FIG. 8. shows the survival of Listeria on grape tomatoes after film treatments (headspace release) and during storage at 4° C. as described below. Data sharing the same letter are not significantly different (P>0.05).

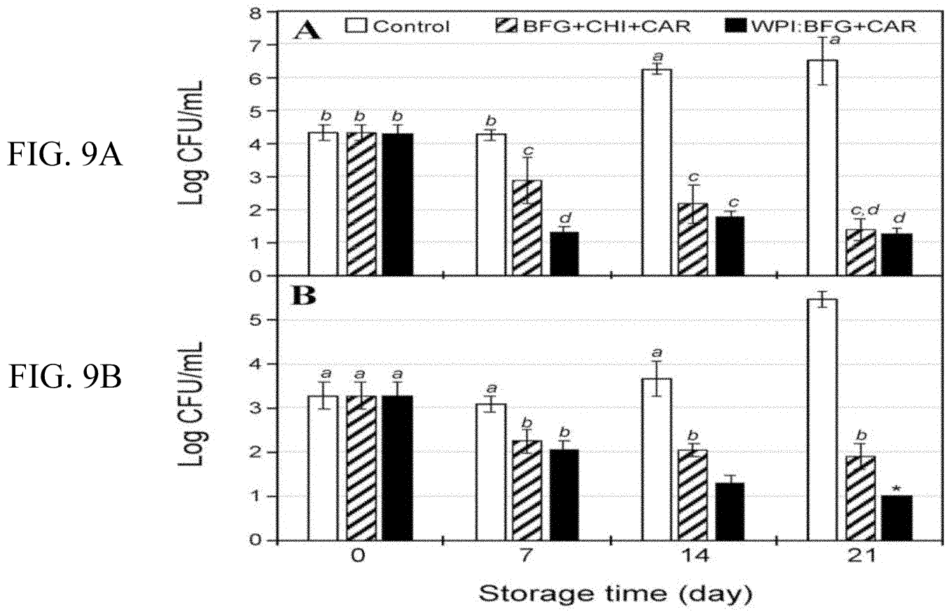

Exemplary FIGS. 9.A and 9.B. shows the survival of native microorganisms on tomatoes after film treatments (headspace release) and during storage at 4° C., as described below. (9.A): TPC; (9.B): YMC.

*Under the detectable limit. Data sharing the same letter are not significantly different (P>0.05).

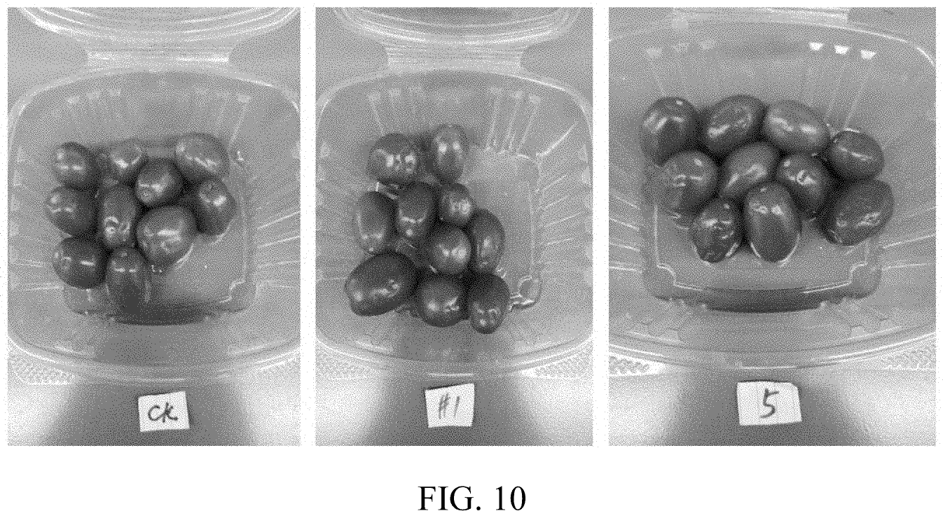

Exemplary FIG. 10, shows the appearance of tomatoes after three weeks at 4° C. as described below. CK: Control; #1: BFG+CHI+CAR; #5: WPI:BFG+CAR.

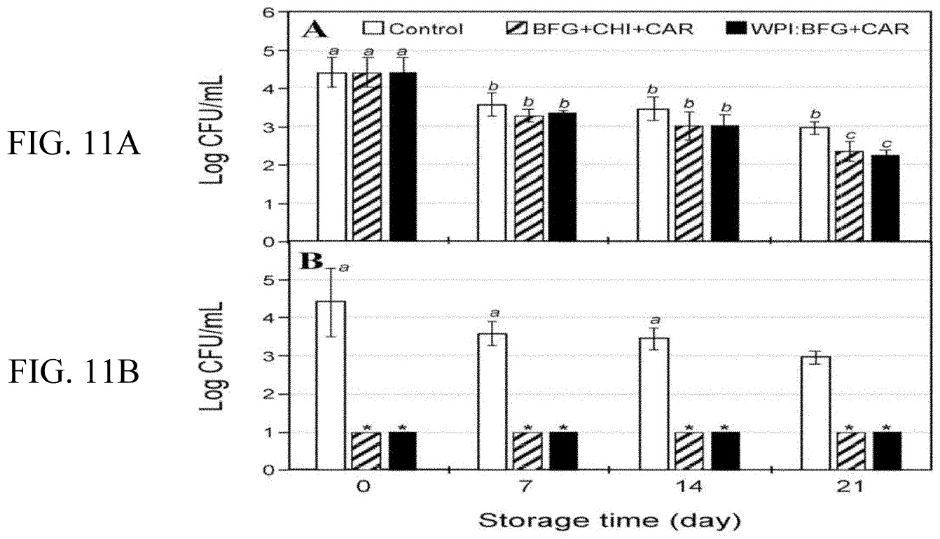

Exemplary FIGS. 11.A. and 11.B. shows the survival of E. coli on fresh-cut apples after treatments and during storage at 4° C., as described below. (11.A): headspace release; (11.B): direct coating. *Under the detectable limit. Data sharing the same letter are not significantly different (P>0.05).

### DETAILED DESCRIPTION OF THE INVENTION

Disclosed herein are compositions suitable for making edible films or coatings, said composition containing a conjugate of bio-fiber gum and whey protein isolate, and at least one food grade antimicrobial (e.g., essential oils: carvacrol).

Preparation of bio-fiber gum (BFG): Bio-fiber gum (BFG) was isolated from corn fiber, which is the main low-value by-product of the corn wet and/or dry milling process in biofuel industries, following previously described procedures (Guo et al., 2015; Qiu, S. et al., Food Chemistry, 230: 225-233 (2017); Yadav, M. P., and K. B. Hicks, Food Hydrocolloids, 78: 120-127 (2018)) with some modification. In brief, the ground de-oiled corn fiber was boiled at about 85° C. with efficient mechanical stirring in the presence of heat-stable Termamyl a-amylase at about pH 6.8 for about 1 hour to hydrolyze starch. Then the pH of this suspension was raised to about 11.5 by adding about 50% NaOH. An aqueous H₂O₂ solution was added to it in a calculated amount to make its concentration in the reaction mixture about 0.63%. The boiling and stirring were continued for about an additional 30 minutes. During the reaction, the pH was maintained at about 11.5 by adding about 50% NaOH. The reaction volume was maintained by adding water as needed to compensate for water loss due to evaporation. The hot slurry of the deconstructed corn fiber was immediately sheared using a high-speed Polytron (PT 10/35 GT) equipped with a 12 mm probe (Kinematica Inc., Bohemia, N.Y.) at about 10,000 rpm for about 30 minutes and cooled to room temperature. The solid fiber residue was separated from the reaction mixture by centrifugation at about 14,000×g for about 10 minutes and discarded. The supernatant was collected in a beaker. Its pH was adjusted to about 4.0-4.5 by adding concentrated HCl to precipitate acid-insoluble hemicellulose A, collected by centrifugation at about 10,000×g for about 30 min and discarded. About two volumes of ethanol were gradually added to the supernatant with stirring to precipitate the acid-soluble hemicellulose B, also called bio-fiber gum (BFG), which was collected by filtration and dried in a vacuum oven at about 50° C.

Preparation of whey protein isolate and bio-fiber gum conjugates (WPI:BFG): The WPI and BFG conjugates (WPI:BFG) was prepared according to our previously published method, which involved a Maillard-type reaction (Qi, P. X. et al., Food Hydrocolloids, 67: 1-13 (2017b); Yadav, M. P. et al., Food Hydrocolloids, 26(2): 326-333 (2012)). Briefly, the powders of WPI and BFG were mixed at a weight ratio of about 3:1, suspended in deionized water (Milli-Q, Millipore, Bedford, Mass.) at a total concentration of about 20 mg/mL, and stirred overnight at room temperature. The pH of the mixture was recorded to be about 6.8. The solution was then freeze dried. The dried sample was gently ground to make a fine powder using a mortar and pestle. The powder was heated at about 75° C. in controlled relative humidity (79%) using a saturated KBr solution for about 48 h. The resultant sample was finely ground and kept in a desiccator in the freezer until used.

Preparation of coating solution and films: BFG (3% w/v), chitosan (1% w/v, CHI), and glycerol (0.5% w/v) with carvacrol (1% v/v, CAR) (BFG+CHI+CAR) or without carvacrol (BFG+CHI), WPI:BFG (3% w/v) and glycerol (0.5% w/v) with 1% CAR (WPI:BFG+CAR) or without CAR (WPI:BFG), were dispersed in an acid solution containing 1% (v/v) acetic acid and lactic acid, and mixed with a stirring bar. To obtain a more homogeneous solution, we homogenized the mixture in a Bullet Blender (Next Advance, Averill Park, N.Y.) using zirconium oxide beads (2.0 mm diameter). The instrument was set at ten-speed for about 12 min. The homogenate was then centrifuged at about 2000×g for about 15 mins to remove any sediments and then used either as a coating solution or to prepare film samples. Ten milliliters of coating solution were cast in 57-mm-diameter aluminum Petri plates and dried at about 40° C. for about 10 h. The films were peeled off from the aluminum Petri plates before use. The average film thickness was 0.22 mm. FIGS. 1.A. and 1.B illustrates the samples of coating solutions and films.

Food grade antimicrobials include, for example, essential oils like carvacrol, ally isothiocyanate, cinnamon, clove, eugenol, oregano, thymol, and others that are from plant sources or chemically synthesized.

For the purposes of this disclosure, the term a “Maillard-type reaction” comprises a reaction that starts with the condensation between the carbonyl group of a reducing end sugar and an unprotonated amino group (mainly ε-amino group of Lysine residue in protein) leading to a Schiff base after releasing a molecule of water. The Schiff base subsequently undergoes an irreversible Amadori rearrangement to produce an open chain Amadori compound, 1-amino-1-deoxy-2-ketose. This Amadori compound does not undergo further rearrangement, if the starting reducing end sugar is a five carbon molecule (pentose). But if the starting reducing end sugar is a six carbon molecule (hexose), the oxygen atom from the C-6 hydroxyl group attacks the C-2 carbonyl group closing the ring to produce a cyclic 1 amino-1-deoxy-D-fructopyranose compound.

The term “food” includes fruits, vegetables, meat products (e.g., beef, pork, poultry, fish, seafood), and prepared products. Particularly included are apples, melons, apricots, peaches, pears, avocados, bananas, artichokes, beans, bell peppers, carrots, celery, corn, garlic, horseradish, leeks, lima beans, mushrooms, onions, parsnips, peas, pimiento, tomato, turnips, lettuce, tomatoes, corn, garlic, horseradish, leeks, lima beans, mushrooms, onions, parsnips, peas, pimiento, tomato, turnips, lettuce, and tomatoes. Foods also include tubers (e.g., Solanum tuberosum including Russet potatoes, Kennebec potatoes, Hilite potatoes, Norkata potatoes, and Norgold potatoes). Foods particularly include fresh-cut produce (e.g., fruits and vegetables), which is produce that has been, for example, peeled, cut, sliced, or shredded.

The fruits and vegetables may be subjected to various processing techniques wherein they are subjected to disorganization of their natural structure, as by peeling, cutting, comminuting, pitting, pulping, freezing, and dehydrating. Meat products include, for example, ready-to-eat (RTE) meats and poultry products, which include a vast array of products such as bacon, ham (whole or partial), fresh or fermented sausages of all types (such as beef, pork, chicken, turkey, fish, etc.), deli and luncheon meats, hotdogs (frankfurters), bologna and kielbasa type products, delicatessen specialties and pates, dried meat and poultry products, such as beef jerky and turkey jerky; and frozen meat and poultry such as pre-cooked frozen beef patties and pre-cooked frozen fried chicken. The term “ready-to-eat meat product” means a meat product that has been processed so that the meat product may be safely consumed without further preparation by the consumer, that is, without cooking or applying some other lethality treatment to destroy pathogens. Thus, unlike other meat products, ready-to-eat meat products are generally consumed without further cooking; therefore, they require that pathogens be rigorously controlled during processing and storage. Meat products also include uncooked meat products.

Other compounds (e.g., antimicrobials known in the art) may be added to the composition provided they do not substantially interfere with the intended activity and efficacy of the composition; whether or not a compound interferes with activity and/or efficacy can be determined, for example, by the procedures utilized below.

“Optional” or “optionally” means that the subsequently described event or circumstance may or may not occur. The description includes instances in which said event or circumstance occurs and instances where it does not. For example, the phrase “optionally comprising an antimicrobial” means that the composition may or may not contain an antimicrobial and that this description includes compositions that contain and do not contain an antimicrobial. Also, for example, the phrase “optionally adding an antimicrobials” means that the method may or may not involve adding an antimicrobial and that this description includes methods that involve and do not involve adding an antimicrobial.

By the term, “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate, effective amount may be determined by one of ordinary skill in the art using only routine experimentation.

The compounds described herein or compositions described herein to be used will be at least an effective amount of the compound or diluted solution of the compound; for fumigation, the compounds used may have to be a pure form (not mixed or adulterated with any other substance or material). Generally the concentration of the compounds will be, but not limited to, about 0.025% to about 10% (e.g., 0.025 to 10%, for example in an aqueous solution), preferably about 0.5% to about 4% (e.g., 0.5 to 4%), more preferably about 1% to about 2% (e.g., 1 to 2).

While this invention may be embodied in many different forms, there are described in detail herein specific preferred embodiments of the invention. The present disclosure is an exemplification of the principles of the invention and is not intended to limit the invention to the particular embodiments illustrated. All patents, patent applications, scientific papers, and any other referenced materials mentioned herein are incorporated by reference in their entirety.

Furthermore, the invention encompasses any possible combination of some or all of the various embodiments and characteristics described herein and/or incorporated herein. In addition, the invention encompasses any possible combination that also specifically excludes anyone or some of the various embodiments and characteristics described herein and/or incorporated herein.

The amounts, percentages, and ranges disclosed herein are not meant to be limiting, and increments between the recited amounts, percentages, and ranges are specifically envisioned as part of the invention. All ranges and parameters disclosed herein are understood to encompass any and all subranges subsumed therein and every number between the endpoints. For example, a stated range of 1 to 10″ should be considered to include any and all subranges between (and inclusive of) the minimum value of 1 and the maximum value of 10, including all integer values and decimal values; that is, all subranges beginning with a minimum value of 1 or more, (e.g., 1 to 6.1), and ending with a maximum value of 10 or less, (e.g., 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions (e.g., reaction time, temperature), percentages, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. As used herein, the term “about” refers to a quantity, level, value, or amount that varies by as much as 10% to a reference quantity, level, value, or amount. For example, about 1.0 g means 0.9 g to 1.1 g, and all values within that range, whether specifically stated or not.

Unless defined otherwise, all technical and scientific terms used herein have the same meaning as commonly understood by one of ordinary skill in the art to which the invention belongs. The definitions herein described may or may not be used in capitalized as well as singular or plural form herein and are intended to be used as a guide for one of ordinary skill in the art to make and use the invention and are not intended to limit the scope of the claimed invention. Mention of trade names or commercial products herein is solely for the purpose of providing specific information or examples and does not imply recommendation or endorsement of such products. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Materials and Methods. Chitosan (low molecular weight, 150 kDa, 75-85% deacetylation) and carvacrol (95% purity) were purchased from Sigma Aldrich (St. Louis, Mo.). Food grade acetic and lactic acids and glycerol were acquired from Fisher Scientific (Fairlawn, N.J.). Termamyl a-amylase was a gift from Novozymes, Davis, Calif. Sodium hydroxide and hydrochloric acid were obtained from Sigma-Aldrich (St. Louis, Mo.). All chemicals were reagent grade. Whey protein isolate (WPI) powder (Provon 190, Lot #1053301027) was a gift from Glanbia Nutritionals, Inc. (Twin Falls, Id.). The components of the spray-dried WPI, according to the suppliers' specifications, are 89.6% protein, 2.5% fat, 2.8% moisture, and 3.3% ash.

Preparation of bio-fiber gum (BFG): Bio-fiber gum (BFG) was isolated from corn fiber, which is the main low-value by-product of the corn wet and/or dry milling process in biofuel industries, following previously described procedures (Guo et al., 2015; Qiu, S. et al., Food Chemistry, 230: 225-233 (2017); Yadav, M. P., and K. B. Hicks, Food Hydrocolloids, 78: 120-127 (2018)) with some modification. In brief, the ground and de-oiled corn fiber was boiled at 85° C. with efficient mechanical stirring in the presence of heat-stable Termamyl a-amylase at pH 6.8 for 1 hour to hydrolyze starch. Then the pH of this suspension was raised to 11.5 by adding 50% NaOH. An aqueous H₂O₂ solution was added to it in a calculated amount to make its concentration in the reaction mixture about 0.63%. The boiling and stirring were continued for an additional 30 minutes. During the reaction, pH was maintained at 11.5 by adding 50% NaOH, and the reaction volume was maintained by adding water as needed to compensate for water loss due to evaporation. The hot slurry of the deconstructed corn fifer was immediately sheared using a high-speed Polytron (PT 10/35 GT) equipped with a 12 mm probe (Kinematica Inc., Bohemia, N.Y.) at 10,000 rpm for 30 minutes and cooled to room temperature. The solid fiber residue was separated from the reaction mixture by centrifugation at 14,000×g for 10 minutes and discarded. The supernatant was collected in a beaker. Its pH was adjusted to 4.0-4.5 by adding concentrated HCl to precipitate acid-insoluble hemicellulose, collected by centrifugation at 10,000×g for 30 min, and discarded. Two volumes of ethanol were gradually added to the supernatant with stirring to precipitate the acid-soluble hemicellulose B, also called bio-fiber gum (BFG), which was collected by filtration and dried in a vacuum oven at 50° C.

Preparation of whey protein isolate and bio-fiber gum conjugates (WPI:BFG): The WPI and BFG conjugates (WPI:BFG) was prepared according to our previously published method (Qi, P. X. et al., Food Hydrocolloids, 67: 1-13 (2017b); Yadav, M. P. et al., Food Hydrocolloids, 26(2): 326-333 (2012)). Briefly, the powders of WPI and BFG were mixed at a weight ratio of 3:1, suspended in deionized water (Milli-Q, Millipore, Bedford, Mass.) at a total concentration of 20 mg/mL), and stirred overnight at room temperature. The pH of the mixture was recorded to be near 6.8. The solution was then freeze dried. The dried sample was gently ground to a fine powder using a mortar and pestle. The powder was heated at 75° C. in controlled relative humidity (79%) using a saturated KBr solution for 48 h. The resultant sample was finely ground and kept in a desiccator in the freezer until used.

Preparation of coating solution and films: BFG (3 w/v), chitosan (1% w/v, CHI), and glycerol (0.5% w/v) with carvacrol (1% v/v, CAR) (BFG+CHI+CAR) or without carvacrol (BFG+CHI), WPI:BFG (3% w/v) and glycerol (0.5% w/v) with 1% CAR (WPI:BFG+CAR) or without CAR (WPI:BFG), were dispersed in an acid solution containing 1% (v/v) acetic acid and lactic acid, and mixed with a stirring bar. To obtain a more homogeneous solution, we homogenized the mixture in a Bullet Blender (Next Advance, Averill Park, N.Y.) using zirconium oxide beads (2.0 mm diameter). The instrument was set at ten-speed for 12 min. The homogenate was then centrifuged at 2000×g for 15 mins to remove any sediments and then used either as a coating solution or to prepare film samples. Ten milliliters of coating solution were cast in 57-mm-diameter aluminum Petri plates and dried at 40° C. for 10 h. The films were peeled off from the aluminum Petri plates before use. The average film thickness was 0.22 mm. FIGS. 1.A. and 1.B. illustrates the samples of coating solutions and films.

Inoculum preparation: Escherichia coli K12 (ATCC 23716), Listeria innocua (ATCC 33090), and Salmonella typhimurium (ATCC 14028) were obtained from the culture collection of the USDA-Eastern Regional Research Center (Wyndmoor, Pa.). Frozen stock cultures of each strain were cultured independently in 30 mL of Tryptic Soy Broth (BBL/Difeo Laboratories, Sparks, Md.) in sterile 50 ml-conical tubes at 37° C. for 18 h. The bread molds (Aspergillus niger, Penicillium corylophilum, and Eurotium repens) were isolated from spoiled bread. The fungal counts were confirmed by inoculation in Dichloran Rose-Bengal Chloramphenicol Agar (DRBC, Remel, Lenexa, Kans.) plates. The incubation was allowed to occur at 25° C. for 5 days (Bernardi, A. O. et al., Food Microbiology, 83: 59-63 (2019); Dagnas, S. et al., Journal of Food Protection, 78(9): 1689-1698 (2015)).

Antimicrobial properties of films: The antimicrobial activity of films was tested in agar plates using direct contact and headspace release methods or in liquid media, as described by Jin & Zhang (Jin, T. Z., and H. Zhang, Journal of Food Science, 73(3): M127-M134 (2008)). In the agar plate tests, DRBC agar plates were surface inoculated with bread fungi. The density of fungi was approximately 10⁸ CFU/ml. For the direct contact method, four pieces of films (total surface area of ca. 9 cm²) were placed on the inoculated agar surface. For the headspace release method, an intact film sample was placed on the box lid's inner surface, or the solution was coated on the inner surface of the Petri dish's lid. The agar plates were incubated at 25° C. for 4 to 5 days. The presence of clear zones surrounding each film specimen after incubation was used to determine each film sample's antimicrobial activity. FIG. 2.A.-2.C. illustrates the test methods.

Four pieces of films (total surface area of ca. 9 cm²) were placed in a glass test tube with 9 mL sterile 0.1% peptone water for the liquid incubation tests. The peptone water in the tube was inoculated with 1 mL of an overnight culture of selected strains and shaken at 25° C. at 100 rpm. One mL of the inoculated peptone water was sampled at each sampling time. Specimens were serially diluted with 0.1% Peptone Water, and 100 μl of the appropriate dilutions were then surface-plated onto Tryptic Soy Agar (TSA) plates for E. coli, PALCAM plates (BBL/Difeo) for Listeria, Xylose Lysine Tergitol 4 Agar (XLT4, BD/Difco) plates for Salmonella, and DRBC plates for fungi. TSA, PALCAM, and XLT4 plates were incubated at 37° C. for 24-48 h, while DRBC plates were incubated at 25° C. for 4-5 days. Inoculated peptone water without a film served as a control. FIG. 3A exemplifies the test method.

Physiochemical properties of films: Oxygen Transmission. OxySense5000 (OxySence, Inc., Dallas, Tex.) was used to measure the oxygen transmission rate (OTR) through the sample film, following the manufacturer's suggested procedures. The measurements were conducted at room temperature (ca 22° C.). The instrument was equipped with software for capturing permeation data and calculating OTR.

Carbon Dioxide Transmission: PERMATRAN-C Model 4/41 (MOCON, Minneapolis, Minn.) was used to measure the carbon dioxide transmission rate (TR) through the sample film following the manufacturer's suggested procedures. The measurements were conducted at room temperature (ca 22° C.). The instrument was equipped with software for capturing permeation data and calculating CO₂ TR.

Mechanical Properties: The mechanical properties of the films were determined according to the Standard method ASTM D882. Films were cut into strips (20 mm×40 mm) and placed in a desiccator for 48 h at 22° C. and 50% relative humidity (RH) by using saturated salt solution potassium chloride (KCl). Tests were performed in Texture analyzer TA.XT.Plus (Stable Micro Systems, UK). The film strip's initial length was set to 21 mm, then was stretched at a constant velocity of 2 mm/min. The stress-strain curves were computer-recorded by software Exponent.

Food applications: For real food applications, tomatoes and fresh-cut apples were used as models. The coatings' and the films' antimicrobial efficacies were investigated by directly applying the coating solution to the food surface and the headspace release method.

Grape tomatoes were evaluated according to the method of Jin & Gurtler (Jin, T. Z., and J. B. Gurtler, Journal of Food Protection, 75(8): 1368-1372 (2012)). Each tomato was washed in tap water to remove any debris. The surface of each tomato was sanitized with 70% ethanol to remove background bacteria. One hundred microliters (100 μl) of selected inoculum were spot inoculated on each stem scar's surface. The inoculum was applied in approximately equal volumes at 10 locations across the tomato stem scar to facilitate drying. Inoculated tomatoes were dried for 2 h at 22° C. in a biosafety hood before coating or headspace treatments. For the surface coating, one mL of the coating solution was evenly pipetted and distributed over each stem scar's entire surface. The coated and non-coated (control) tomatoes were placed in a 12-oz polyethylene terephthalate (PET) clamshell container (Genpak, Glens Falls, N.Y.) for 21 days at 4° C. For the headspace treatments, the inoculated tomatoes were placed in the clamshell container with a piece of film stuck on the lid's inner surface. Tomatoes that were not subject to washing and inoculation were used to determine the native microorganism populations following the procedures mentioned above. Each box contained ten tomatoes, and two replicate boxes were used for each experiment.

On sampling days, each tomato stem scar (ca. 2 g each) was excised by hand in a conical manner from the fruit, added to 5 mL of sterile peptone water in a Whirl-Pak filter bag, and carefully macerated in the bag on the lab bench with a small mallet. The macerated samples in the filter bags were then pummeled in a stomacher for 2 min. Sample filtrates were surface plated in duplicate onto TSA plates for E. coli, PALCAM plates for Listeria, PCA plates for native bacteria (TPC), and DRBC plates for yeasts and molds (YMC). The TSA plates, PALCAM plates, and PCA plates were incubated at 37° C. for 24-48 h, and DRBC plates were incubated at 25° C. for 4-5 days before colonies were counted.

Fresh-cut apples were evaluated according to the method of Jin et al. (Jin, T. Z. et al., Journal of Food Safety, 40(4): e12802 (2020)). Each apple was surface sanitized before inoculation using the abovementioned procedure for tomatoes. Each apple was cut into small one in² pieces, dip-inoculated in the diluted inoculum for thirty seconds, and dried under the biohood for two hours to allow bacterial cells to adhere to the surface. After two hours, the inoculated apple pieces were dip-coated for one minute in one of the coating solutions and dried under the biohood for two hours. The apple pieces that were not dipped in the coating solutions served as controls. After 2 h of drying, the slices were placed into individual 12-oz polyethylene terephthalate (PET) clamshell containers for 7 days at 4° C. For headspace treatments, the inoculated apple slices were placed in the clamshell container with a piece of film stuck on the lid's inner surface. Each box contained four apple slices, and three replicated boxes were used for each experiment.

Two apple pieces from each treatment were placed into an individual Whirl-Pak bag containing 10 mL of 0.1% Peptone Water on sampling days. The homogenates for each sample were prepared, and bacterial and fungal populations were determined according to the procedure mentioned above for tomatoes.

Statistical analysis: Data were evaluated by analyzing the variance (ANOVA) and LSD's multiple range test using the SAS software (Statistical Analysis Systems Institute, Cary, N.C.). The differences between the mean values were presented at the 5% significant level (p<0.05). All experiments were replicated two or three times.

Results and Discussion: In our preliminary studies, over ten coating solutions and films were developed and evaluated for their potential antimicrobial activities and physicochemical properties. Among them, four films were selected for further study, and their results are reported here. FIGS. 1.A. and 1.B. shows the samples of coating solutions (A) and films after drying (B) that were evaluated in this study.

Antimicrobial properties: In vitro tests in peptone water and agar plates were used to determine the antimicrobial properties of the coatings and films in our preliminary studies. Four methods were applied, two with direct contact (films on agar surface and in peptone water) and two indirect contacts (films on the box lid or coating on the petri dish cover), as shown in FIG. 2.A.-2.C. and FIG. 3.A.-3.B.

FIG. 2.A.-2.C. show how the film samples were placed on the agar surface, inside the box lids, and the film solutions were coated on the petri dish and dried before use, respectively. All plates were inoculated with the same bread fungi and incubated at the same temperature. After 4 to 5 days of incubation, the clear plates indicated no fungal growth on the plates compared with the controls. These results revealed that the three agar methods achieved similar levels of fungal inhibition.

FIG. 4.A.-4.B. shows the antimicrobial properties of the films evaluated in peptone water using the liquid incubation method. Four film samples were selected for this study. Films without carvacrol (BFG+CHI and WPI:BFG) reduced Salmonella populations in peptone water from 7.4 logs to 2.1 and 2.5 logs, respectively, on day 0; Salmonella populations were further reduced to an undetectable limit (<1 log CFU/ml) after one-day incubation. Both films with carvacrol (BFG+CHI+CAR and WPI:BFG+CAR) surprisingly reduced Salmonella populations to an undetectable limit on day 0 (FIG. 4A). However, bread fungi showed higher resistance to the film treatments than Salmonella. Films without carvacrol reduced fungal populations by less than 0.5 logs after one day and 1 log after two days of incubation (FIG. 4B). Surprisingly the presence of carvacrol in the films (BFG+CHI+CAR and WPI:BFG+CAR) significantly enhanced their antimicrobial activity and reduced fungal populations to an undetectable limit after two days (FIG. 4B).

The films' antimicrobial activities without carvacrol can be attributed to chitosan and acids in the formulation released into the liquid media. The antimicrobial role of chitosan and organic acids in antimicrobial coatings was reported by Jin and Gurtler (2012). Surprisingly, the results from this study using the liquid incubation method showed that the film treatments led to more significant Salmonella population reductions. Without being bound by theory, the strong fungal resistance to film treatments was likely due to their ability to adapt to an acidic environment (Vylkova, S., PLoS Pathogens, 13(2): e1006149 (2017)).

To further investigate how long the films maintained their antimicrobial properties or how many times the films can be reused, we used the same films multiple times. FIG. 5.A. shows that the films in the boxes were continuously reused seven times for 35 days at 25° C. The boxes were opened and replaced with freshly inoculated agar plates each time. The colony densities on the plates after a 5-day incubation period indicated the antimicrobial properties of the film.

Surprisingly, there was no difference between the two films reused two times and ten days (FIG. 5.B. and FIG. 5.C.). However, increased colonies were observed for BFG+CHI film after 15 days (FIG. 5.D.), and no difference between BFG+CHI film and control (CK) after 20 days (FIG. 5.E.); while WPI:BFG film, reused five times, surprisingly only showed colonies after 25 days (FIG. 5.F) and 30 days (FIG. 5.G.). Both films completely lost their antifungal activities through headspace release after being reused seven times throughout the 35-day incubation period (FIG. 5.H.).

Physicochemical properties: FIG. 3 also shows the water solubility of films. All film samples were incubated in peptone water for 24 h. During this time, all film samples absorbed water and gradually dissolved except for the WPI:BFG and WPI:BFG+CAR films, which surprisingly remained intact (FIG. 3.A.). When the films were incubated on agar plates, they also absorbed moisture and exhibited swelling, and some of them also melted after I-day incubation. However, the WPI:BFG+CAR film surprisingly maintained its original shape after five incubation days on the agar plate (FIG. 2. A.).

Oxygen permeability is an essential parameter for food packaging materials. If environmental oxygen passes through the packaging material, then the packaged food's fatty acids are oxidized, quality deteriorates, and shortened shelf-life occurs. FIG. 6.A-6.C. shows the oxygen transmission profiles of the film samples used in this work. After a certain amount of time, the oxygen content (%) in the package was leveled off at a constant level, 9.0%, 14.0%, 5.7%, and 8.2% for the BFG+CHI+CAR, BFG+CHI, WPI:BFG+CAR, and WPI:BFG films. These results demonstrated that oxygen permeability was surprisingly lower for the films with carvacrol (BFG+CHI+CAR and WPI:BFG+CAR) than those without carvacrol (BFG+CHI and WPI:BFG). Furthermore, the permeability to oxygen was surprisingly lower for the conjugated films than that of non-conjugated (composite) films, i.e., WPI:BFG+CAR vs. BFG+CHI+CAR and WPI:BFG vs. BFG+CHI.

The CO₂ permeability of the films was 361, 522, 315, and 446 cc/(m²-day) for BFG+CHI+CAR, BFG+CHI, WPI:BFG+CAR, and WPI:BFG, respectively. The permeability to CO₂ was also surprisingly lower for the conjugated than that of non-conjugated films.

The mechanical properties of the films are shown in Table 1. Surprisingly, the films with carvacrol (BFG+CHI+CAR and WPI:BFG+CAR) had higher tensile stress, elongation, elastic modulus, and toughness than those without carvacrol (BFG+CHI and WPI:BFG). Among them, the WPI:BFG films surprisingly had better mechanical properties than the BFG+CHI. These results indicated that incorporating both carvacrol and WPI+BFG conjugate in the formulation surprisingly improved the films' mechanical properties.

Applications in real foods: Tomatoes and fresh-cut apples were used as models to evaluate the films' antimicrobial properties for real foods. Two films with carvacrol (BFG+CHI+CAR and WPI:BFG+CAR) were selected for the application study. Direct surface coating and headspace release methods were used for comparison.

Tomatoes were inoculated with E. coli by either surface coating with the coating solutions via the direct application method or placing them in the boxes with films on the lids (headspace release method). FIG. 7.A-7.B. shows the survival of E. coli cells on the tomatoes during storage for 21 days at 4° C. While E. coli populations on the tomatoes without film treatment decreased by approximately 1 log CFU throughout the storage period, surprisingly, the films on the lids reduced these populations to an undetectable limit (<1 log CFU) after 7 days, and this level was maintained throughout the same storage period (21 days at 4° C.). There were no significant differences between the two films (FIG. 7A). Direct application of the coating solution on the tomato surface surprisingly achieved similar reductions in microbial populations, except those tomatoes which were subject to treatment with BFG+CHI+CAR film had slightly higher populations on day 7 (FIG. 7B). It is worth noting that the direct coating application reduced E. coli populations by over 3.5 log on day 0.

In contrast, the headspace film release method did not reduce microbial populations on day 0 (FIG. 7A). This difference was because the direct coating application to the inoculated surface allowed the antimicrobial agent to directly contact the bacterial cells, enabling its antimicrobial effect to occur immediately. In the headspace release method, the antimicrobial agent (carvacrol) was gradually released from the film to the headspace and required time to accumulate to the desired concentration around food samples, thus delaying its antimicrobial effect.

Listeria innocua, a surrogate for Listeria monocytogenes, was inoculated on tomatoes and treated with films in the lids. The results are shown in FIG. 8. Both films significantly reduced Listeria populations by 3.7 log throughout the 21-day storage period at 4° C. The tomatoes subjected to treatment with WPI:BFG+CAR film had slightly higher cell populations than those subjected to treatment with BFG+CHI+CAR film on day 7 and day 14. By day 21, however, there were surprisingly no significant differences in L. innocua populations between them.

The headspace release method was also used to determine the antimicrobial effect of these films on native microflora populations in tomatoes. While the populations of native microorganisms in the controls increased throughout storage, both films significantly reduced the TPC (FIG. 9A) and YMC (FIG. 9B). WPI:BFG+CAR film surprisingly showed higher antimicrobial activity against YMC than BFG+CHI+CAR (FIG. 9B), which confirmed the results from the agar plate method (FIG. 5). FIG. 10 shows the appearance of the tomatoes after 21-day storage at 4° C.

Similar to tomatoes, fresh-cut apples were inoculated with E. coli and treated with the direct surface coating and the headspace release methods. FIG. 11.A-11.B. shows the survival of E. coli on apple slices during storage at 4° C. The headspace film treatment gradually reduced the population to approximately 2.2 logs after seven days (FIG. 11A). However, the direct coating treatment reduced the population to an undetectable level throughout the same storage period (FIG. 11B). The antimicrobial efficacy of the surface coating for fresh-cut apples (FIG. 11B) was similar to that observed in the grape tomatoes (FIG. 7B). The headspace treatments' antimicrobial efficacy was lower in apples (FIG. 11A) than in grape tomatoes (FIG. 7A). Without being bound by theory, a possible explanation for this was that the wet surface of fresh-cut apples could form a protective layer, preventing the gaseous antimicrobial (carvacrol) from effectively contacting bacterial cells and decreasing its antimicrobial efficacy.

We have shown previously (Guo et al., 2018; Guo et al., 2015; Guo et al., 2017) that the BFG+CHI composite films and coatings with allyl isothiocyanate (AIT) inactivated Listeria innocua in tryptic soy broth (TSB) by reducing over 4 log CFU/ml after two days at 22° C. and on the surface of ready-to-eat (RTE) meat samples after 35 days at 10° C. The films also reduced the populations of Escherichia coli O157:H7 and Salmonella spp. by over 5 and 2 log CFU in TSB and strawberries, respectively. Similar results were achieved in this study for the BFG+CHI composite films and coatings containing carvacrol. Film and coating treatments drastically reduced E. coli, Salmonella, and Listeria populations on tomatoes and fresh-cut apples (FIG. 7.A-7.B., FIG. 8, FIG. 11.A.-11.B.) and significantly inhibited bread fungi in the in vitro tests (FIG. 2.A.-2.C., FIG. 5A.-5.H.). Both AIT and carvacrol are essential oils of plant sources and are used as antimicrobials in various foods (Yu & Jaenicke, 2020). Carvacrol was used in the current study instead of AIT because it has a less pungent odor.

It was noted that the BFG+CHI composite films were sensitive to moisture and melted quickly upon contact with a wet surface or when placed in water (FIG. 3.A.-3.B.), confirming that BFG and chitosan are hydrophilic polymers. Dehydration of food products can be limited using such edible films as moisture barriers. The weak mechanical protection can also limit foods with a wet surface after the film melts. Furthermore, when an antimicrobial agent is added to the film or coating, the polymer's encapsulation capacity is essential for the controlled release of the agent. Therefore, the properties of the polymer play a critical role in edible antimicrobial films and coating.

Whey protein isolate (WPI) is a mixture of highly purified (>90%) and primarily hydrophilic proteins. The main component proteins of WPI are β-lactoglobulin (˜50%), α-lactalbumin (˜25%), bovine serum albumin, and various immunoglobulins (Kinsella, J. E., and D. M. Whitehead, Advances in Food and Nutrition Research, 33: 343-438 (1989)). Whey proteins, a by-product of the cheese manufacture, have been a popular and intense research subject in the field of edible films for decades (Mitchell, J. et al., Biochimica et Biophysica Acta, 200(1): 138-150 (1970); Ramos, O. L. et al., Critical Reviews in Food Science and Nutrition, 52(6): 533-552 (2012)).

Although these films exhibit excellent oxygen permeability (OP), they possess inadequate water vapor permeability (WVP) due to their hydrophilic nature (Krochta, J. M., Control of mass transfer in food with edible coatings and films, IN: R. P. Singh & M. A Wirakartakusumah (Eds.), Advanced in Food Engineering (pp. 517-538), Boca Raton, Fla.: CRC Press, 1992; Mate, J. I., and Krochta, J. M., Journal of Agricultural and Food Chemistry, 44(10): 3001-3004 (1996)). Additionally, whey protein films are brittle and must be plasticized with a plasticizer such as glycerol (Guilbert, S. et al., Packaging Technology and Science, 8(6): 339-346 (1995)). In other words, there are limitations to whey proteins as food packaging materials. The emulsifying and foaming properties of the WPI and polysaccharide conjugates (formed through a dry-state Maillard reaction) as encapsulation systems have been widely studied (Nooshkam, M., and Varidi, M., Food Hydrocolloids, 100: 105389 (2020); Qi, P. X. et al., Food Hydrocolloids, 69: 86-96 (2017a); Yadav, M. P. et al., Food Hydrocolloids, 26(2), 326-333 (2012); Zhang, Q. et al., Critical Reviews in Food Science and Nutrition, 59(15): 2506-2533 (2019)). Thus far, to our knowledge, only a few studies carried out the reaction in the dry state as film-forming and coating materials (Choi, K. O. et al., Food Science and Biotechnology, 19(4): 957-965 (2010); Wooster, T. J., and M. A. Augustin, Food Hydrocolloids, 21(7): 1072-1080 (2007); Zhang, X. et al., Food Science, 5: 014 (2011)). The potential of WPI-based films to be used as antimicrobial coating and packaging materials remains to be explored.

In the current study, the combination of WPI:BFG conjugates with carvacrol and organic acids improved the antimicrobial and physicochemical properties of these films and coatings compared with the combination of BFG+CHI with carvacrol and organic acids. Surprisingly the WPI:BFG conjugates significantly enhanced the film's gas barrier properties and increased its water resistance (FIG. 3.A.-3.B.). The mechanisms behind WPI:BFG conjugates in improving antimicrobial and physicochemical properties will be further investigated in a separate study.

Edible films and coatings, acting as barriers to the transfer of moisture, oxygen, and carbon dioxide, can prevent quality deterioration and increase the food products' safety and shelf life through the controlled release of encapsulated antimicrobials. E. coli O157:H7, Salmonella spp., and Listeria monocytogenes are the top three foodborne pathogens associated with many outbreaks on ready-to-eat foods, such as fresh produce (Carstens, C. K. et al., Frontiers in Microbiology, 10: 2667 (2019)). The films and coatings developed in this study surprisingly demonstrated outstanding antimicrobial efficacy against these pathogens either by direct contact or indirect method using in vitro tests or real food applications (FIG. 2.A.-2.C., FIG. 4.A.-4.B., FIG. 5A.-5.H., FIG. 7.A.-7.B., FIG. 8, FIG. 9.A.-9.B., FIG. 11.A.-11.B.). Additionally, mold free-shelf life is an enormous challenge for the bakery industry, with bread being particularly susceptible to fungal spoilage. The most frequently found genera in bakery products are Penicillium, Aspergillus, and Eurotium (dos Santos, J. L. P. et al., Food Research International, 87: 103-108 (2016); Le Lay, C. et al., Food Control, 60: 247-255 (2016)). Microbial spoilage of bread and the consequent waste problem causes considerable economic losses for the bakery industry and consumers. Furthermore, the presence of mycotoxins due to fungal contamination in cereal products remains a significant safety issue (Leyva Salas, M. et al., Microorganisms, 5(3): 37 (2017)). In this study, the in vitro tests surprisingly demonstrated the films' strong antifungal properties (FIG. 2.A.-2.C., FIG. 5.A.-5.H.), indicating their potential applications in bakery products. These films will be further studied in actual bakery products in the near future.

It is concluded that WPI:BFG conjugate films and coatings with antimicrobial(s) surprisingly possessed comparable or superior antimicrobial and physicochemical properties to the BFG+CHI composite films. Therefore, these films and coatings have tremendous potential for food safety enhancement and shelf-life extension. The developed application methods (direct coating and headspace release) provided the flexibility to commercialize these films and coatings for the packaging or food industries. To the best of our knowledge, this is the first report on creating the WPI:BFG conjugate and applying it as an edible food packaging film and coating material.

All the references cited herein, including U.S. patents and U.S. patent Application Publications, are incorporated by reference in their entirety. Also incorporated by reference in their entirety are the following references: U.S. Patent Application Publication 20180125110 (application Ser. No. 15/344,912 filed on 11 Nov. 2016).

Thus, in view of the above, there is described (in part) the following:

A composition suitable for making edible films or coatings, said composition comprising (or consisting essentially of or consisting of) a conjugate of bio fiber gum and whey protein isolate, and at least one food grade antimicrobial.

The term “consisting essentially of” excludes additional method steps or composition components that substantially interfere with the intended activity of the methods or compositions of the invention and can be readily determined by those skilled in the art (e.g., from a consideration of this specification or practice of the invention disclosed herein). This term may be substituted for inclusive terms such as “comprising” or “including” to more narrowly define any of the disclosed embodiments or combinations/sub-combinations thereof. Furthermore, the exclusive term “consisting” is also understood to be substitutable for these inclusive terms in alternative forms of the disclosed embodiments.

The invention illustratively disclosed herein suitably may be practiced in the absence of any element (e.g., method (or process) steps or composition components) which is not specifically disclosed herein. Thus, the specification includes disclosure by silence (“Negative Limitations In Patent Claims,” AIPLA Quarterly Journal, Tom Brody, 41(1): 46-47 (2013):

“ . . . Written support for a negative limitation may also be argued through the absence of the excluded element in the specification, known as disclosure by silence . . . . Silence in the specification may be used to establish written description support for a negative limitation. As an example, in Ex parte Lin [No. 2009-0486, at 2, 6 (B.P.A.I. May 7, 2009)] the negative limitation was added by amendment . . . . In other words, the inventor argued an example that passively complied with the requirements of the negative limitation . . . was sufficient to provide support . . . . This case shows that written description support for a negative limitation can be found by one or more disclosures of an embodiment that obeys what is required by the negative limitation.”

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims. Although any methods and materials similar or equivalent to those described herein can be used in the practice or testing of the present invention, the preferred methods and materials are herein described. Those skilled in the art may recognize other equivalents to the specific embodiments described herein which equivalents are intended to be

TABLE 1
Mechanical properties of films

| | Max. Tensile | | Elastic | |
|---|---|---|---|---|
| | Stress | Elongation | Modulus | Toughness |
| Film Sample | (MP) | (%) | (MP) | (MP) |
| BFG + CHI + CAR | 4.82 | 129.87 | 10.76 | 5.65 |
| BFG + CHI | 4.30 | 102.80 | 8.56 | 5.38 |
| WPI:BFG + CAR | 7.64 | 130.33 | 21.47 | 8.81 |
| WPI:BFG | 6.25 | 115.87 | 16.70 | 5.75 |

encompassed by the claims attached hereto.

We claim:

1. A composition suitable for making edible films or coatings, the composition comprising a conjugate of bio fiber gum and whey protein isolate and at least one food grade antimicrobial.

2. The composition of claim 1 wherein the whey protein isolate (WPI) is conjugated with the bio fiber gum (BFG) at a mass ratio of about 3:1WPI:BFG.

3. The composition of claim 1 wherein the conjugate of bio fiber gum and whey protein isolate is created through a modified through a Maillard-type reaction.

4. The composition of claim 1 wherein the of bio fiber gum and whey protein isolate is used as a film-forming material to improve the film's functionalities, including antimicrobial properties, water sensitivity, gas permeability, and mechanical strength.

5. The composition of claim 1 wherein the bio fiber gum comprises a corn fiber.

6. The composition of claim 1 wherein the bio fiber gum comprises hemicellulose B.

7. The composition of claim 1 wherein the at least one food grade antimicrobial is selected from the group consisting of essential oils including carvacrol, allyisothiocyanate, cinnamon, clove eugenol, oregano, thymol, and other oils that are from plant sources or chemically synthesized.

8. A method of making edible films or coatings, the method comprising the steps of:
(a) providing a mixture comprising whey protein isolate and bio fiber gum (about 3% w/v), and glycerol (about 0.4%) and about 1% carvacrol;
(b) dispersing the mixture in an acid solution containing about 1% (v/v) acetic acid and lactic acid;
(c) mixing with a stirring bar;
(d) homogenizing the mixture with a blender;
(e) centrifuging the homogenate;
(f) coating a plate with the centrifuged homogenate; and
(g) drying the centrifuged homogenate into a film or a coating.

9. The method of claim 8 wherein the whey protein isolate (WPI) is conjugated with the bio fiber gum (BFG) at a mass ratio of about 3:1 (WPI:BFG).

10. The method of claim 8 wherein, in step (a), the mixture comprises chitosan (CHI) (1% w/v) rather than WPI.

11. The method of claim wherein 8 wherein the BFG is conjugated with the CHI at a mass ratio of about 3:1 BFG:CHI.

12. The method of claim 11 wherein the WPI:BFG has generally superior qualities relative to the BFG:CHI.

13. The method of claim 8 wherein, in step (a) the mixture contains no carvacrol.

14. The method of claim 8 wherein, in step (e) the mixture is centrifuged using zirconium oxide beads.

15. The method of claim 8 wherein, in step (g) the mixture is dried at about 40° C. for about 10 hours.

16. The method of claim 8 further comprising:
(g) peeling the coating or film off of the plate, the average thickness of the coating or film being about 22 mm.

17. A film or coating product produced by the process of claim 8.
